(19) United States
(12) Patent Application Publication
(10) Pub. No.: US 2019/0235758 A1
(43) Pub. Date: Aug. 1, 2019

(54) Autonomic Data Compression for Balancing Performance and Space

(71) Applicant: International Business Machines Corporation, Armonk, NY (US)

(72) Inventors: M. Corneliu Constantinescu, San Jose, CA (US); Leo Shyh-Wei Luan, Saratoga, CA (US); Wayne A. Sawdon, San Jose, CA (US); Frank B. Schmuck, Campbell, CA (US)

(73) Assignee: International Business Machines Corporation, Armonk, NY (US)

(21) Appl. No.: 15/881,920

(22) Filed: Jan. 29, 2018

(51) Int. Cl. G06F 3/06; G06F 17/30

(52) U.S. Cl. CPC G06F 3/0608; G06F 3/0644; G06F 17/30153; G06F 3/067; G06F 3/0619; G06F 3/0659; G06F 3/065

(57) ABSTRACT

Autonomic compression including balancing performance of a compression technique and storage space savings in data storage based on an access characteristic is provided. The access characteristic of file data is determined including a read access and/or a write access. A space management action is dynamically selected to be applied to the file data. The selection automatically balances between a storage size and an access performance of the file data based on the access characteristic. The selected space management action is applied on the file data including changing a state of compression of the data.

### BACKGROUND

The present embodiments relate to autonomic data compression. More specifically, the embodiments related to balancing performance of a compression technique and storage space savings in data storage based on an access characteristic.

Data may be stored in different persistent storage devices, such as hard disk drives and solid state drives. As the quantity of data increases, so must the quantity of storage space on the persistent storage drive. Increasing the data storage size of the persistent storage device increases the cost of the persistent storage device. Similarly, in a cloud environment, storage space may be purchased based on quantity.

Data compression may be utilized to limit the amount of storage space needed and thereby limit the cost of storing the data. Data compression utilizes a compression technique to reduce the storage size of data. There are different compression techniques, each associated with a compression ratio and a performance characteristic. The compression ratio and performance characteristic of a compression technique are inversely related. For example, the higher the performance characteristic the lower the compression ratio. Therefore, performance needs and space needs are considered when selecting a compression technique.

### SUMMARY

A system, computer program product, and method are provided for autonomic compression including balancing performance of a compression technique and storage space savings in data storage based on an access characteristic.

In one aspect, a system with a processor in communication with data storage and an autonomic configuration (AC) engine for file data management is provided. The AC engine determines an access characteristic of file data. More specifically, the AC engine tracks access to the file data including a read access and/or a write access. Based on the determined access characteristic, the AC engine dynamically selects a space management action which includes a compression, de-compression, and/or re-compression, to be applied to the file data. The space management action is associated with a compression ratio and performance characteristic. The selection automatically balances between storage size and access performance of the file data. The AC engine applies the selected space management action on the file data.

In another aspect, a computer program product is provided for file data management. The computer program product includes a computer readable storage medium with embodied program code that is configured to be executed by a processor. Program code determines an access characteristic of file data. More specifically, program code tracks access to the file data including a read access and/or a write access. Based on the determined access characteristic, program code dynamically selects a space management action which includes a compression, de-compression, and/or re-compression, to be applied to the file data. The space management action is associated with a compression ratio and performance characteristic. The selection automatically balances between storage size and access performance of the file data. Program code applies the selected space management action on the file data.

In yet another aspect, a method is provided for file data management. An access characteristic of file data is determined. More specifically, access to the file data including a read access and/or a write access of the selected data is tracked. Based on the determined access characteristic, a space management action which includes a compression, de-compression and/or re-compression, is dynamically selected to be applied to the file data. The space management action is associated with a compression ratio and performance characteristic. The selection automatically balances between storage size and access performance of the file data. The selected space management action is applied on the file data.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram illustrating a computer system for autonomic data compression.

FIG. 2 depicts a flow chart illustrating a method for autonomic compression of a new or newly updated file data.

FIG. 3 depicts a flow chart illustrating a method for autonomic compression of file data performed as a background process.

FIG. 4 depicts a flow chart illustrating a method for autonomic re-activation of recently read file data.

FIG. 5 depicts a flow chart illustrating a method for autonomic re-activation of recently written file data.

FIG. 6 depicts a block diagram illustrating the multiple states of compression of file data.

FIG. 7 depicts a flow chart illustrating a method for dynamic selection of a partition size.

FIG. 8 is a block diagram illustrating an example of a computer system/server of a cloud based support system, to implement the process described above with respect to FIGS. 1-7.

FIG. 9 depicts a block diagram illustrating a cloud computer environment.

FIG. 10 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, and method of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment of the present embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Systems with a single fixed compression technique or compression data format result in inefficient data access performance. For example, data compressed with a first compression technique which has a low compression ratio and fast performance characteristic utilizes less system resources and reduces latency during data access as compared to a second compression technique which has a high compression ratio and slow performance characteristic. However, limiting the aspect of storing all data with the first technique inefficiently utilizes space. Similarly, limiting the aspect of storing all data with the second compression technique inefficiently utilizes system resources (e.g., increases processing cycles to access data). Accordingly, a balance between performance of the compression technique and storage space savings within data storage benefits use of system resources.

A system, method, and computer program product are disclosed and described herein for autonomic compression to balance performance of a compression technique and storage space savings in data storage based on an access characteristic. The access characteristic of file data is determined, including a time of a read access and/or a write access. The access characteristic is compared to a rule in order to determine the temperature of the data. In one embodiment, the temperature relates to a prediction of future access requests for the data. A space management action is dynamically selected to be applied to the file data. The selection automatically balances between storage size and access performance of the file data based on the determined temperature. The selected space management action is applied on the file data including changing a state of compression of the data. Accordingly, file data stored in data storage is subject to autonomic compression based on an associated access characteristic.

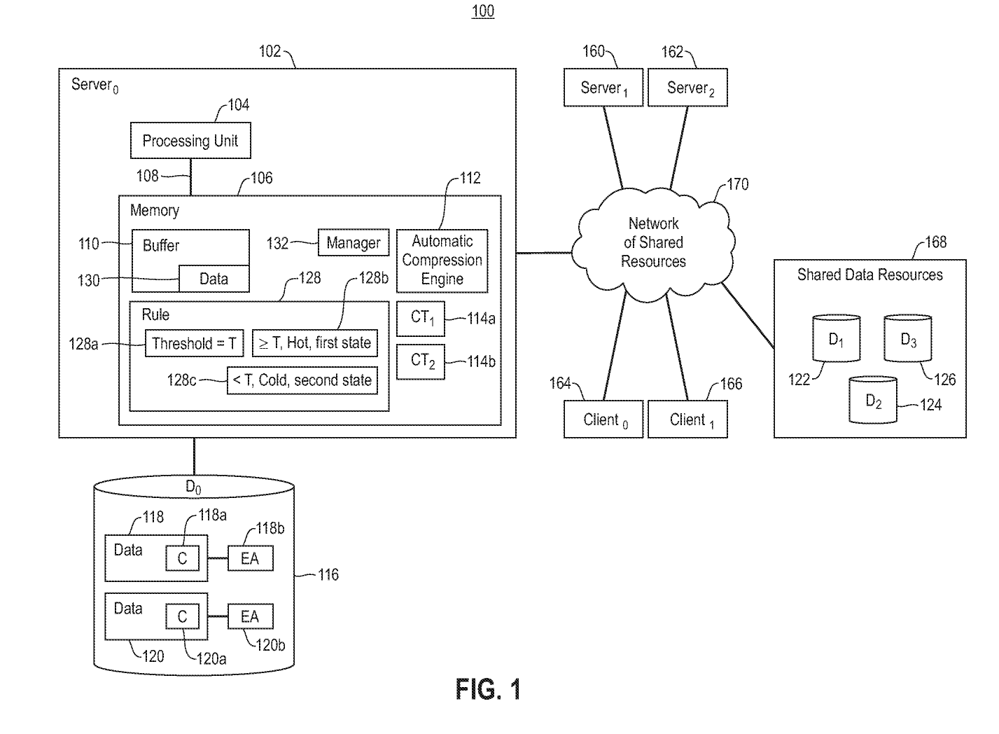

Referring to FIG. 1, a block diagram (100) is provided illustrating a computer system for autonomic data compression. The system is shown with multiple servers, client machines, and shared resources in communication across a network. System tools for autonomic data compression as shown are embedded in server₀ (102), although in one embodiment the system tools may be provided on another machine in the network or in one embodiment distributed across multiple machines in the network. Server₀ (102) is shown configured with a processor (104) in communication with a memory (106) across a bus (108). In one embodiment, system tools for autonomic compression are accessible to other devices through a network connection. For example, server₀ (102) is also shown in communication with a network of shared resources (170) across a network connection to access shared resources, including, but not limited to, shared data resources (168), client machines, client₀ (164) and client₁ (166), and other servers, server₁ (160) and server₂ (162). The quantity of client machines, servers, and data resources shown and described herein are for illustrative purposes and should not be considered limiting.

Server₀ (102) is operatively coupled to local data storage, D₀ (116). Similarly, shared data resources (168) is configured with multiple data storage devices, shown herein as D₁ (122), D₂ (124), and D₃ (126). Server₀ (102) is configured with system tools for autonomic compression such as, an autonomic compression (AC) engine (112), a buffer (110), and at least one rule (128). As shown, the AC engine (112) is stored in memory (106) for execution by processing unit (104), although in one embodiment, the AC engine (112) may be in the form of an application operatively coupled to the memory (106) for execution by the processing unit (104). The AC engine (112) is in communication with local data storage, D₀ (116). In one embodiment, the AC engine (112) is in communication with shared data resources (168), including storage devices D₁ (122), D₂ (124), and D₃ (126). The AC engine (112) may be local to a client machine, such as client₀ (164) or another server, such as server, (160). Accordingly, the location of data storage D₀ (116), D₁ (122), D₂ (124), and D₃ (118), buffer (110), rule (128), and AC engine (112) shown herein is for illustrative purposes and should not be considered limiting.

As shown, manager (132) is stored in memory (106) for execution by processing unit (104). The manager (132) is provided with functionality to support a read and/or write of file data from/to data storage, D₀ (116), and in one embodiment, data storage D₁ (122), D₂ (124), and D₃ (126). For example, manager (132) supports a read request for file data, such as file data (118) and/or (120) from data storage D₀ (116). In one embodiment, manager (132) supports a read request for file data from data storage D₁ (122), D₂ (124), and/or D₃ (126). Similarly, manager (132) supports a write request including writing file data (130) from buffer (110) to data storage, such as D₀ (116) and in one embodiment, to data storage D₁ (122), D₂ (124), and/or D₃ (126). File data (130) is stored in buffer (110). In one embodiment, the file data (130) may be new file data to be stored in data storage, such as D₀ (116), D₁ (122), D₂ (124), and/or D₃ (126). Similarly, in one embodiment, the file data (130) may be data that has been read from data storage, such as D₀ (116), D₁ (122), D₂ (124), and/or D₃ (126) and updated with new data. In one embodiment, buffer (110) is cache memory. Accordingly, the manager (132) supports access of file data in data storage, including a read and/or write access.

Read and/or write access to file data (118) and (120) stored in D₀ (116) is tracked by AC engine (112), in communication with manager (132), utilizing access characteristics (118a) and (120a) respectively. The access characteristic may be a time of, but not limited to, a write access and a read access. In one embodiment, the read access tracked in the access characteristic is the most recent read access relative to the current time. In one embodiment, the write access tracked in the access characteristic is the most recent write access relative to the current time. The quantity of tracked accesses should not be considered limiting. Accordingly, file data (118) and (120) are associated with an access characteristic (118a) and (120a) respectively for tracking access history.

In one embodiment, the access characteristic (118a) is a timestamp of when a read and/or write access occurred. More specifically, the access characteristic (118a) may include, but is not limited to, a last modify (e.g., write) timestamp (mtime) and a last access (e.g., read/write) timestamp (atime). The timestamp, mtime, is used to determine a quantity of time that has passed since the file data has last been updated (e.g., current time−mtime). The timestamp, atime, is used to determine how long the file has been inactive (e.g., current time−atime). The AC engine (112) utilizes the mtime and/or the atime in support of autonomic compression and a space management action selection process as described in detail below. Accordingly, the access characteristic may provide the last time the data was modified and/or the last time the data has been accessed.

In one embodiment, the access characteristics (118a) and (120a) include an access pattern. The access pattern may be, but is not limited to, a frequency of access, a size of file data accessed, and randomness of access. For example, frequency of access may be how often the file data is accessed in support of a read and/or write request (e.g., once a minute, twice an hour, three times a day, once a month, etc.). Size of file data access may be a quantity of the file data that was used to support a read/write access. Randomness of access may be, but is not limited to, random access pattern and sequential access pattern. Accordingly, the access characteristics (118a) and (120a) are provided with information to support the manner in which the file data (118) and (120) was accessed respectively.

As shown, file data (118) is associated with extended attribute (118b) and file data (120) is associated with extended attribute (120b). The Extended attributes (118b) and (120b) may include, but are not limited to, a record for recent accesses over a defined period of time, access characteristics for individual blocks within the file data, and access characteristics for groups of blocks within the file data. Thus, the extended attributes (118b) and (120b) provide access history information including file data granularity down and block level granularity. In one embodiment, the extended attributes (118b) and (120b) include a heat indicator. The heat indicator may define the temperature of the data (e.g., “cold”, “hot”, etc.) based on a prediction of future access as described in detail below. In one embodiment, the extended attributes (118b) and (120b) may define the state of compression the file data should be in. For example, the extend attribute may define, never compress, compress to a first state of compression, and compress to a second state of compression. Accordingly, the extended attribute may provide access history down to data block level granularity and track temperature of the file data.

The AC engine (112) is provided with functionality to manage a state of compression of one or more data files within data storage, D₀ (116), and in one embodiment, one or more data files within D₁ (122), D₂ (124), and/or D₃ (126). The AC engine (112) provides a balance between performance of a compression technique and storage space savings within the managed data storage. For example, AC engine (112) is provided with functionality to perform a space management action on the file data, such as file data (118) and/or (120). The space management action may be, but is not limited to, compression, de-compression, and re-compression (e.g., de-compression and compression). The space management action may include the use of a compression technique such as, compression technique₁ (CT₁) (114a), and/or compression technique₂ (CT₂) (114b) to support the compression, de-compression, and/or re-compression. The compression technique may be a lossy (e.g., inexact) compression method such as, but not limited to, discreet cosine transform, vector quantization, and Huffman code. The compression technique may be a lossless (e.g., exact) compression method, such as, but not limited to, run length encoding, grammar-based coding, string-table compression, and Lempel ziff welch. Accordingly, the AC engine (112), supported by one or more compression techniques, manages the state of compression of file data within data storage, D₀ (116).

The compression technique may be, but is not limited to, zlib and lz4. In one embodiment, CT₁ (114a) is lz4 and CT₂ (120a) is zlib. In one embodiment, CT₂ (114b) has a first compression ratio higher than a second compression ratio of CT₁ (114a). Similarly, in one embodiment, CT₂ (114b) has a first performance characteristic slower than a second performance characteristic of CT₁ (114a) (e.g., with CT₂ (114b) consuming more cycles from processing unit (104) than CT₁ (114b) to compress and/or de-compress the same file data. In one embodiment, a compression action utilizing CT₁ (114a) compresses file data (118) from an un-compressed state to a first state of compression and a compression action utilizing CT₂ (120a) compresses file data (118) from an un-compressed state to a second state of compression, wherein the first and second states of compression are different. In one embodiment, the second state of compression of file data (118) occupies less storage space in D₀ (116) relative to the first state of compression of file data (118). In one embodiment, the second state of compression of file data (118) requires more processing cycles from processing unit (104) to de-compress the file data (118) than the first state of compression of file data (118). The quantity of compression techniques and type of compression techniques should not be considered limiting.

AC engine (112) is configured to dynamically select a space management action including a compression technique, such as CT₁ (114a) and CT₂ (114b). The dynamic selection process includes application of an autonomic multi-tier reaction system to the file data. For example, a determination of an access characteristic, such as access characteristics (118a) and (118b), of file data (118) and (120), respectively, is made and in one embodiment, a state of compression of the file data is determined. The AC engine (112) compares the determined state of compression and the determined access characteristic to rule (128) including one or more parameters of the rule, such as parameter (128a), (128b) and (128c). The comparison includes a determination of whether the state of compression of the file data is proper based on the determined access characteristic. In one embodiment, rule (128) includes a threshold parameter (128a) utilized in comparison to the access characteristic. Based on the threshold, the AC engine (112) determines the temperature of the data utilizing parameters (128a)-(128c). For example, if the determined access characteristic meets or exceeds the threshold (128a), the file data is considered “hot” and the file data should be in a first state of compression based on parameter (128b). Contrastingly, if the determined access characteristic is below the threshold (128a), the file data is considered “cold” and the file data should be in a second state of compression based on parameter (128c). In one embodiment, following the comparison, AC engine (112) may augment extended attributes (118b) and/or (120b) with the temperature determination. Accordingly, the AC engine (112), supported by rule (128), determines the temperature of file data and whether the file data is in the proper state of compression.

In one embodiment, rule (128) includes multiple tiers (not shown), wherein each tier is defined with a state of compression and a threshold. The threshold may be a value, a temperature, a range of values, and/or a range of temperatures. For example, rule (128) may define “hot” data in a first state of compression has a first threshold in a first tier. Similarly, rule (128) may define “warm” data in a third state of compression has a third threshold in a second tier, and “cold” data in a second state of compression has a second threshold in the third tier. In one embodiment, each tier is associated with a compression technique. The quantity of tiers and thresholds within rule (128) should not be considered limiting.

In one embodiment, rule (128) is associated with a service level agreement. For example, the service level agreement may define a quantity of file data associated with an entity that is allowed to be stored in each state of compression. In one embodiment, there are multiple rules and each rule is associated with a different service level agreement. In one embodiment, the value of threshold(s) within rule (128) is dependent on the service level agreement. In one embodiment, the value of threshold(s) within rule (128) is dependent on the data storage where the file data will be stored. Accordingly, rule (128) supports a determination by AC engine (112) of which state of compression each file data within data storage should be stored based on the access characteristic.

If the determined state of compression is improper based on the comparison, the AC engine (112) initiates a process to change the state of compression of the file data to the proper state. The state change process includes the AC engine (112) dynamically selecting a space management action based on the determined state of compression, the determined access characteristic, and the rule (128). For example, if file data (130) is in an uncompressed state, the AC engine (112) may select a first space management action of compression utilizing CT₁ (114a). In another example, if file data (118) is in the first state of compression and access characteristic (118a) is determined to be below the threshold (128a) in rule (128) (e.g., “cold” file data), the AC engine (112) may select a second space management action on file data (118). The second space management action includes re-compression utilizing CT₁ (114a) to de-compress file data (118) to an uncompressed state and thereafter compress file data (118) utilizing CT₂ (114b) from the uncompressed state to the second state of compression. In another example, if file data (120) is in the second state of compression and access characteristic (120a) is determined to meet or exceed the threshold (128a) in rule (128) (e.g., “hot” file data), the AC engine (112) may select a third space management action on file data (120). The second space management action includes re-compression utilizing CT₂ (114b) to de-compress file data (120) to an uncompressed state and thereafter compress file data (120) with CT₁ (114a) from the uncompressed state to the second state of compression. Following dynamic selection of the space management action, the AC engine (112) applies the space management action to the file data. However, following a determination that file data is in a proper state of compression, the AC engine (112) does not select or perform a space management action. Accordingly, the AC engine (112) manages the state of compression of file data in the data storage utilizing space management actions and one or more compression techniques.

In one embodiment, the AC engine (112) may use the access characteristics (118a) and (120a) to dynamically determine a partition size to be used in support of the dynamic selection of the space management action. For example, the AC engine (112) may examine the access characteristics (118) and/or (120). Based on the examination, the AC engine (112) dynamically selects a first partition size for file data with a sequential access pattern and a second partition size for file data with a random access pattern. The first and second partition sizes are different. In one embodiment, the first partition size is larger than the second partition size. In one embodiment, the partition size is proportional to a compression ratio of the compression action. Thus, a larger partition size may lead to a greater storage space savings relative to a smaller partition size. However, storing randomly accessed data in a partition larger than the data in support of the random access may result in inefficient system resource utilization. For example, all data within the randomly accessed partition has to be uncompressed to service the random access. Thus, even though the larger partition may enable greater storage space savings, the larger partition may introduce higher resources utilization (e.g., increase processing cycles required to access the data) relative to a smaller partition since other data unrelated to the random access has to be de-compressed and/or re-compressed along with the randomly accessed data. After the selection of the partition size, the AC engine (112) utilizes the selected partition size in the space management action. Accordingly, the access characteristic (118a) and (120a) supports a dynamic selection of partition size in support of the space management action.

The AC engine (112) is configured to perform the space management action in-line and out-of-line with storage of file data. For example, in-line performance is an operation where the AC engine (112) compresses file data (130) in memory (106) as the file data (130) is being written to the data storage, D₀ (116) by manager (132) but before the file data (130) is written to the data storage, D₀ (116). In contrast, out-of-line performance is an operation where the AC engine (112) compresses file data (130) after the file data (130) is written to data storage, Do (116) by manager (132). In-line performance may reduce the amount of input/output (I/O) operations server₀ (102) will have to perform to support a write operation by the manager (132) since the file data (130) has been compressed prior to the write operation. In-line performance provides immediate storage space savings in the data storage, D₀ (116), however, in-line performance initially utilizes more system resources (e.g., processor cycles from processing unit (104)) during the storage of the file data (130) than out-of-line performance since in-line performance has to perform the compression as the file data (130) is being written to data storage, D₀ (116). Out-of-line performance enables system resource utilization in server₀ (102) to be spread out over a longer period of time than in-line performance. In one embodiment, the out-of-line performance occurs when the system resource utilization in server₀ (102) is below a threshold and/or at a select time. In one embodiment, out-of-line performance occurs when a compression group is present in the data storage, D₀ (116). Accordingly, the AC engine (112) performs the space management action in-line or out-of-line with storage of the file data.

The AC engine (112) may determine whether to perform the space management action in-line or out-of-line based on a determination of whether a compression group is present in buffer (110). The compression group is based on the compression technique dynamically selected to be utilized in the space management action. For example, if a whole and/or significant portion of a compression group of uncompressed blocks is present in buffer (110), the AC engine (112) performs the space management action on file data (130) in-line with storage of file data (130) by manager (132). However, if a compression group is not present in buffer (110), the manager (132) may store the file data (130) in an un-compressed state and the AC engine (112) may perform the space management action out-of-line. Accordingly, the AC engine (112) performs the space management action in-line with storage of file data when a compression group is present and out-of-line with storage of file data when a compression group is absent.

The AC engine (112) may scan data storage, such as D₀ (116), D₁ (122), D₂ (124), and D₃ (126) in order to determination whether file data is in the proper state of compression. In one embodiment, the scan of the data storage is a background process. In one embodiment, the scan is activated by, but not limited to, a time interval, a performance parameter of server₀ (102) and/or data storage, such as D₀ (116), D₁ (122), D₂ (124), and/or D₃ (126), and a quantity of available storage space in buffer (110) and/or data storage, such as D₀ (116), D₁ (122), D₂ (124), and/or D₃ (126). Based upon the scan, the AC engine (112) determines the state of compression of file data and an access characteristic associated with the file data. The AC engine (112) compares the state of compression of file data and the access characteristic associated with the file data to rule (128) and determines if the state of compression of the file data is proper. If the state of the file data is proper, the AC engine (112) does not select and perform the space management action. However, if the state of compression is improper, the AC engine (112) dynamically selects and performs the space management action on the file data thereby putting the file data in the proper state. In one embodiment, the AC engine (112) may be integrated with a job scheduler to initiate performance of a space management action as a predictive measure (e.g., preparation for a future workload) instead of as a reactive measure (e.g., responsive to current workload). In one embodiment, the space management action may be delayed for a predefined period of time. Accordingly, the AC engine (112) may passively scan data storage in order to determine if the compression state of the file data should be changed.

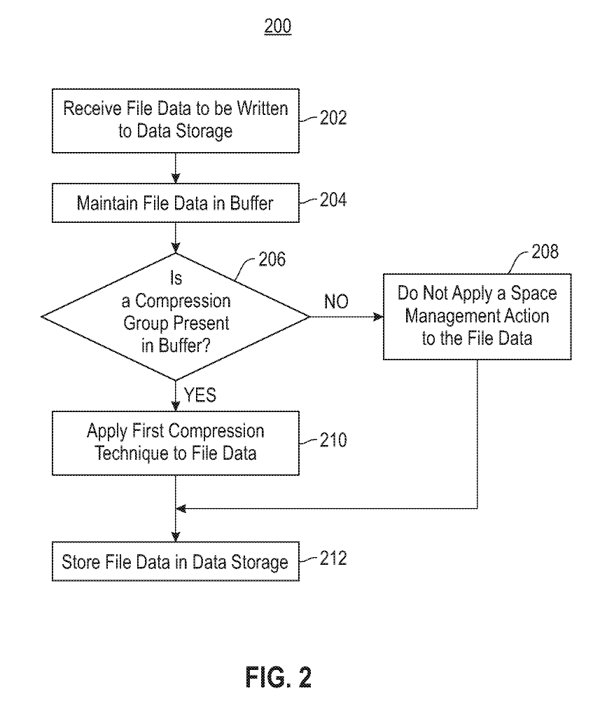

Referring to FIG. 2, a flow chart (200) is provided illustrating a method for autonomic compression of new or newly updated data file. As shown, file data to be written to data storage is received (202) and maintained in a buffer (204). A determination is made if the data maintained in the buffer is a whole compression group (206). A compression group is a quantity of data blocks that are compressed together based on the space management action to be performed. In one embodiment, each compression group is compressed separately. Following a determination that the whole compression group is present in the buffer at step (206), a space management action including a first compression technique is applied to the file data in-line with the storage of the file data in data storage (212). In one embodiment, a significant part of the compression group being present in the buffer results in a positive determination at step (206). The quantity of the compression group that has to be present at step (206) may be defined by a compression group rule. However, following a determination that a compression group is not present in the buffer at step (206) a space management action is not applied to the file data (208) and the file data is stored in data storage in an uncompressed state (212). In one embodiment, the first compression technique emphasizes performance characteristics relative to a second compression technique (e.g., the first compression technique consumes less processing cycles than the second compression technique). The un-compressed file data may be subject to a space management action at a later time (e.g., out-of-line compression). Accordingly, new file data to be written to data storage is compressed in-line or out-of-line with storage of the file data utilizing the first compression technique.

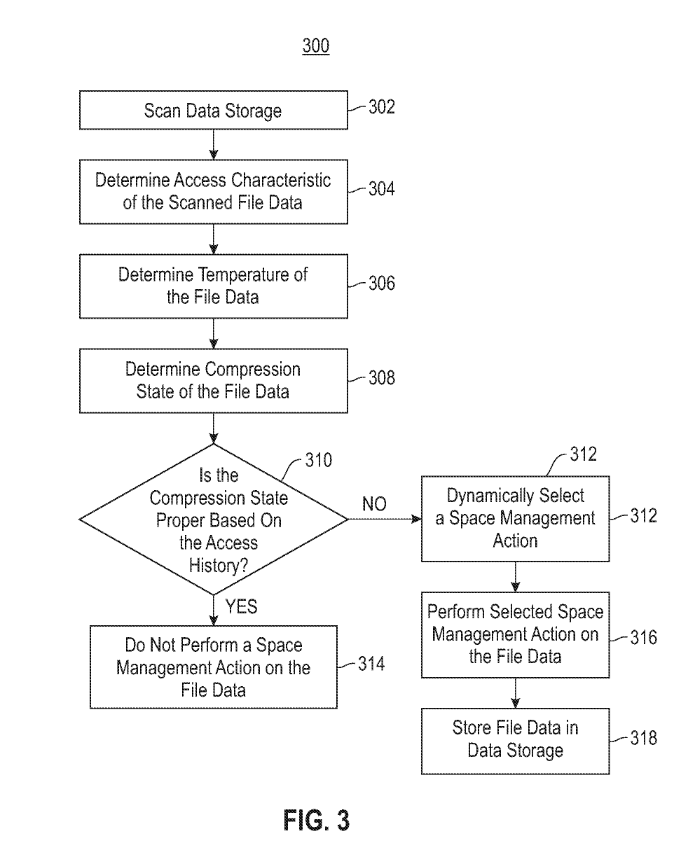

The autonomic compression process may be applied in-line or out-of-line with storage of the data file as shown and described in FIG. 2. The autonomic compression process may also be applied as a background process based on a scan of the data storage. Referring, to FIG. 3, a flow chart (300) is provided illustrating a method for autonomic compression of file data performed as a background process. As shown a background process is initialized to scan the data storage including file data within the data storage (302). The background scan includes determining an access characteristic of the scanned file data (304). Based on the determined access characteristic, the temperature of the file data is determined (306). The temperature may be, but is not limited to, “cold” or “hot”. In one embodiment, “cold” file data has an access characteristic below an access threshold, and “hot” file data has an access characteristic meeting or exceeding the access threshold. The quantity of temperature designations are for illustration purposes and should not be consider limiting. In one embodiment, the temperature determination includes a comparison of the determined accessed characteristic to a temperature rule. In one embodiment, a state of compression of the scanned data is determined (308). The state of compression of the file data and the determined temperature are compared to a compression rule to determine if the file data is in the proper state of compression (310). For example, uncompressed data, “hot” data in a second compressed state, and “cold” data in a first compressed state are in improper states. Similarly, “hot” data in the first state of compression, and “cold” data in the second state of compression are in proper states. Accordingly, the temperature of the file data is utilized to determine if the file data is in the proper state of compression.

As shown, following a positive determination at step (310) that the file data is in the proper state of compression, the process concludes and a space management action is not performed on the file data (314). However, following a determination that the file data is in an improper state of compression at step (310), a space management action is dynamically selected (312). The dynamic selection is based on the state of compression of the file data determined at step (308) and the temperature of the file data determined at step (306). For example, for uncompressed data a compression action utilizing the first compression technique is chosen. In another example, for “hot” data in the second state of compression a first re-compression action is chosen, including a de-compression action utilizing the second compression technique and a compression action utilizing the first compression technique. Similarly, for “cold” data in a first compressed state a second re-compression action is chosen, including a de-compression action utilizing the first compression technique and a compression action utilizing the second compression technique. In one embodiment, the dynamic selection at step (312) includes a selection of a compression partition size. The dynamically selected space management action is performed on the file data (316) including changing the state of compression of the file data. The file data with the change state of compression is stored in the data storage (318). Accordingly, the space management action is dynamically selected based on the temperature of the file data and applied to the file data.

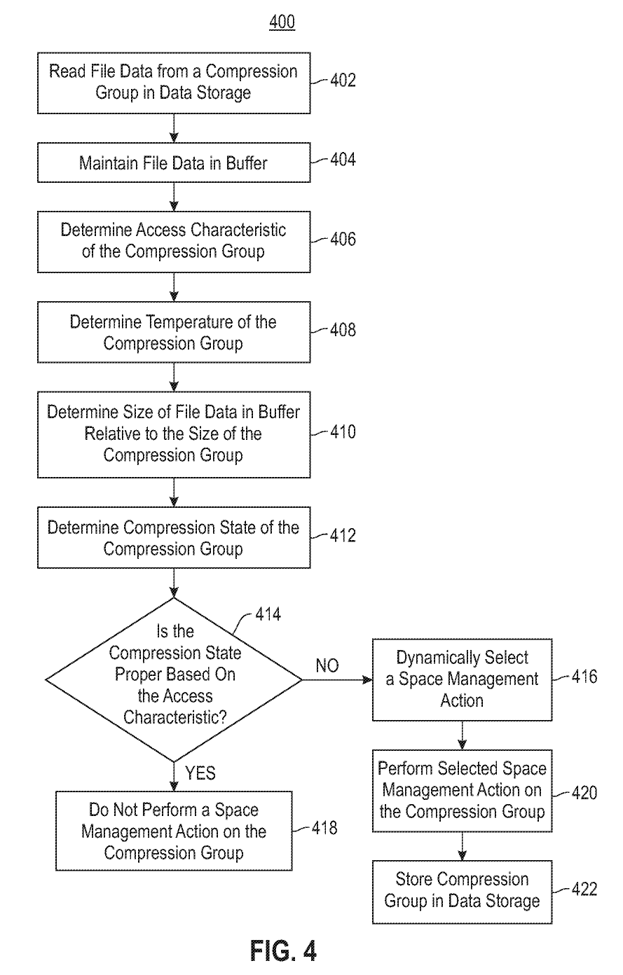

The autonomic compression process may be utilized in a background process as shown and described in FIG. 3. Additionally, the autonomic compression process may re-activate a compression group of recently read data. Referring, to FIG. 4, a flow chart (400) is provided illustrating a method for autonomic re-activation of recently read file data. As shown, file data which is a portion of a compression group is read from data storage in support of a read request (402). For example, when a read request is received, only a portion of the compression group that contains the requested data is read, which optimizes the amount of I/O being used to service the read request. In one embodiment, serving the read request includes an in-line de-compression of the requested data of the compression group. The newly read file data is maintained in a buffer (404). In one embodiment, the newly read file data is maintained in the buffer at step (404) in the state of compression. In one embodiment, the newly read file data is maintained in the buffer at step (404) in an uncompressed state. Accordingly, file data is read from a compression group and stored in the buffer.

The access characteristic of the compression group that supported the read request is determined (406). In one embodiment, the determination at step (406) is an aggregation of access characteristics of two or more file data within the compression group. Based on the determined access characteristic, the temperature of the compression group is determined (408). In one embodiment, the temperature determination includes a comparison of the access characteristic to a temperature rule. The size of the file data is determined and compared to the size of the compression group to determine a relative size (410). In one embodiment, a state of compression of the scanned data is determined (412). The state of compression of the compression group, the determined temperature of the compression group, and the relative size of the read file data are compared to a compression rule to determine if the compression group is in the proper state of compression (414). For example, a compression group in a second state of compression where the relative size of the read file data meets or exceeds a size threshold, and a compression group that is determined to be “hot” and/or trending towards becoming “hot” based on the access characteristic are in improper states. Similarly, a compression group deemed “cold” where the relative size of the read file data is below the size threshold is in a proper state. Accordingly, the temperature of the compression group and relative size of the read data are utilized to determine if the compression group is in the proper state of compression.

As shown, following a positive determination at step (414) that the data is in the proper state of compression, the process concludes and a space management action is not performed on the compression group (418). However, following a determination that the compression group is in an improper state of compression at step (414), a space management action is dynamically selected (416). The dynamic selection is based on the state of compression of the compression group determined at step (412) and the temperature of the compression determined at step (408). The dynamically selected space management action is performed on the compression group including changing the state of compression of the compression group (420). In one embodiment, the dynamically selected space management action is also performed on the read file data maintained in the buffer. The compression group with the changed state of compression is stored in the data storage (422). Accordingly, the space management action is dynamically selected based on the temperature of the compression group and the space management action is applied to the compression group.

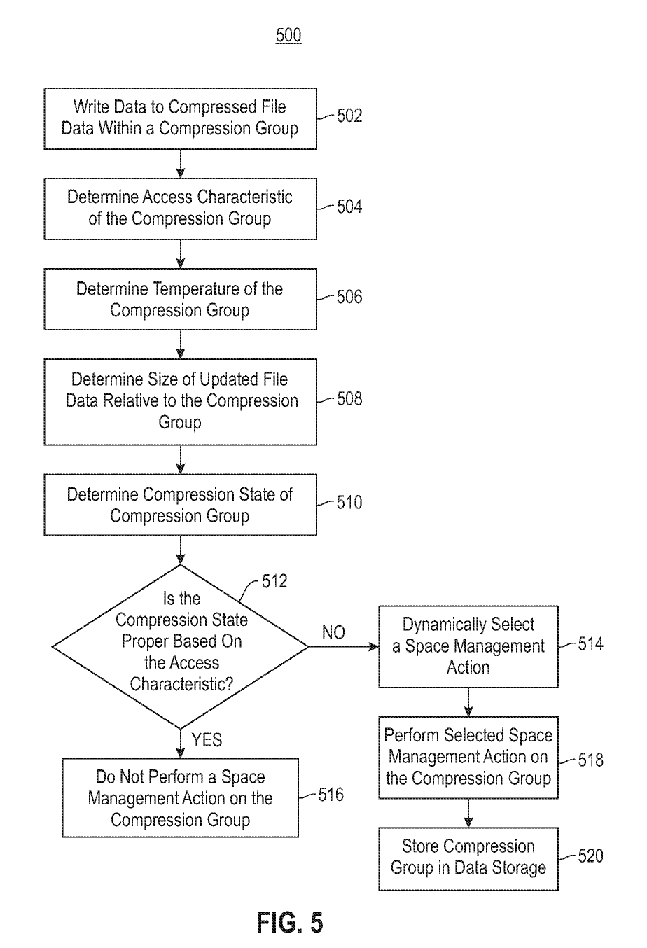

The autonomic compression process can be applied to recently read data and the compression group the recently read data came from. Similarly, the autonomic compression process may be applied to recently written file data. Referring to FIG. 5, a flow chart (500) is provided illustrating a method for autonomic re-activation of recently written file data. As shown, data is written to compressed file data within a compression group in data storage (502). For example, when a write request is received, only a portion of data blocks within the compression group that contains the requested data may be updated with the write request which optimizes the amount of I/O being used to service the write request. The other data blocks not subject to the write request are not updated. Accordingly, new data is written to file data within a compression group.

The access characteristic of the compression group that the data was written to is determined (504). In one embodiment, the determination at step (504) is an aggregation of access characteristics of two or more file data within the compression group. Based on the access characteristic, the temperature of the compression group is determined (506). In one embodiment, the temperature determination includes a comparison of the access characteristic to a temperature rule. The size of the updated file data supporting the write request is compared to the compression group to determine a relative size (508). In one embodiment, a state of compression of the compression group is determined (510). The state of compression of the compression group, determined temperature of compression group, and relative size of the file data supporting the write request are compared to a compression rule to determine if the compression group is in the proper state of compression (512). For example, a compression group in a second state of compression where the relative size of the file data supporting the write request meets or exceeds a size threshold, and a compression group determined to be “hot” and/or trending towards being “hot” based on the access characteristic are in improper states. Similarly, a compression group deemed “cold” where the relative size of the file data supporting a write request is below the size threshold is in a proper state. Accordingly, the temperature of the compression group and relative size of the read data are utilized to determine if the compression group is in the proper state of compression.

As shown, following a positive determination at step (512) that the data is in the proper state of compression, the process concludes and a space management action is not performed on the compression group (516). However, following a determination that the compression group is in an improper state of compression at step (512), a space management action is dynamically selected (514). The dynamic selection is based on the state of compression of the compression group determined at step (510) and the temperature of the compression determined at step (506). The dynamically selected space management action is performed on the compression group including changing the state of compression of the compression group (518). The compression group with the changed state of compression is stored in the data storage (520). Accordingly, the space management action is dynamically selected based on the temperature of and the space management action is applied to the compression group supporting the write request.

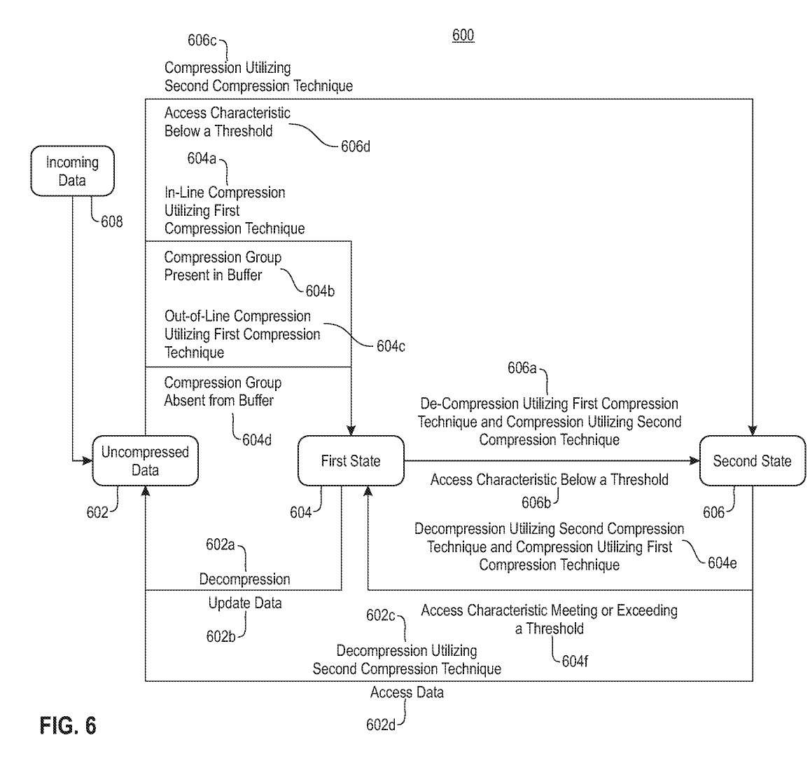

In FIGS. 1-5, various states of compression are shown and described. Referring to FIG. 6, a block diagram (600) is provided illustrating the multiple states of compression of file data. As shown, incoming uncompressed file data (608) is stored in a buffer in an uncompressed state (602). The new file data may be subject to compression utilizing the first compression technique which occur in-line (604a) or out-of-line (604c) with storage of the file data. The compression with the first compression technique changes the file data from the uncompressed state (602) to a first state of compression (604). The compression occurs in-line with storage of the file data (604a) when a compression group is present in the buffer (604b) and out-of-line (604c) when a compression group is absent from the buffer (604d). In one embodiment, the first compression technique which occur in-line (604a) and/or out-of-line (604c) is responsive to an access characteristic of the file data determined to meet or exceed a threshold. Accordingly, uncompressed data may be transformed into the first state of compression utilizing the first compression technique.

Similarly, the file data in the uncompressed state (602) may be subject to compression utilizing the second compression technique (606c). For example, the file data in the uncompressed state (602) is subject to the second compression technique (606c) responsive to the access characteristic of the file data determined to be below the threshold (606d). The compression with the second compression technique changes the file data from the uncompressed state (602) to a second state of compression (606). In one embodiment, the second compression technique (606c) occurs out-of-line. Accordingly, uncompressed data may be transformed into the second state of compression utilizing the second compression technique.

The file data in the first state of compression (604) may be subject to a first re-compression (606a) and/or a first decompression (602a). For example, the file data in the first state (604) is subject to the first re-compression (606a) responsive to the access characteristic of the file data determined to be below the threshold (606b). The first re-compression includes a de-compression of the file data in the first state utilizing the first compression technique to an un-compressed state and a re-compression of the file data utilizing a second compression technique (606a) to change the file data from the uncompressed state to a second state of compression (606). In another example, the data is subject to the first de-compression utilizing the first compression technique (602a) responsive to an update (e.g. write) and/or read of the file data (602b) and the updated file data is maintained in the buffer in an un-compressed state (602). Accordingly, the first state of compression of the file data is subject to change.

The file data in the second state (606) may be subject to a second re-compression (604e) and/or a second de-compression (602c). For example, the file data in the second state of compression (606) is subject to the second re-compression (604e) responsive to an access characteristic of the file data determined to meet or exceed the threshold (604f). The second re-compression includes a de-compression of the file data in the second state to an un-compressed state and a re-compression of the file data with the first compression technique (604e) to change the file data from the uncompressed state to the first state of compression (604). In another example, the data is subject to a second de-compression utilizing the second compression technique (602c) responsive to an update (e.g. write) and/or read of the file data (602d) and the updated data is maintained in the buffer and in one embodiment, in an un-compressed state (602). In one embodiment, block diagram (600) illustrates a decision tree in a rule for determining a proper state of file data and supporting dynamic selection of a space management action. Accordingly, the state of compression of the file data is subject to dynamic change.

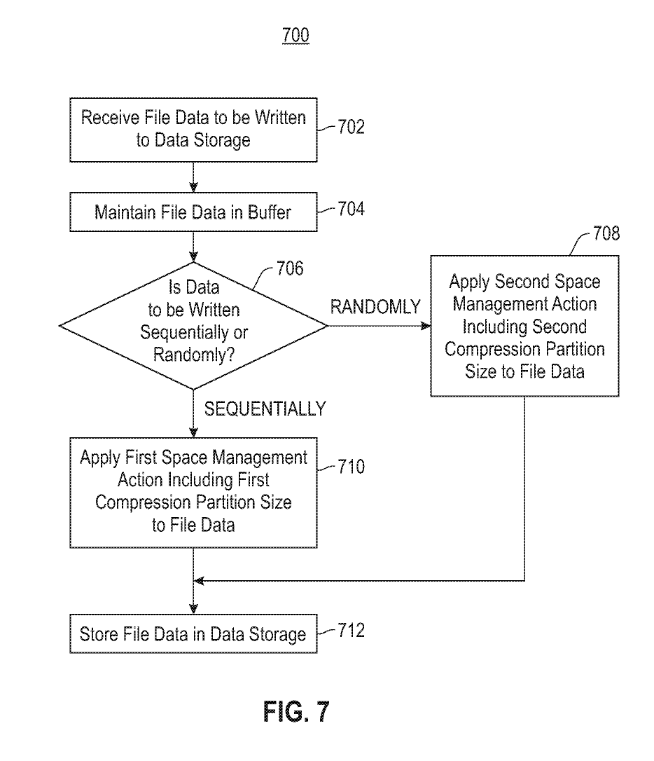

Referring to FIG. 7, a flow chart (700) is provided illustrating a method for dynamic selection of a partition size. As shown, file data to be written to data storage is received (702). The received file data is maintained in a buffer (704) and a determination is made if the data maintained in the buffer is to be written sequentially or randomly (706). Following a determination that the file data is to be written sequentially at step (706), a first space management action including a first compression partition size is dynamically selected and applied to the file data (710). The compressed sequential file data is stored in data storage (712). However, following a determination that a the file data is to be written randomly at step (706) a second space management action including a second compression partition size is dynamically selected and applied to the file data (708) and the file data is stored in the data storage (712). In one embodiment, the first and second compression partition sizes are different. In one embodiment, the first compression partition size is larger than the second compression partition size. In one embodiment, the partition size is proportional to the compression ratio. Accordingly, the compression partition size is dynamically selected for file data based on the access type (e.g., random access or sequential access) of the file data.

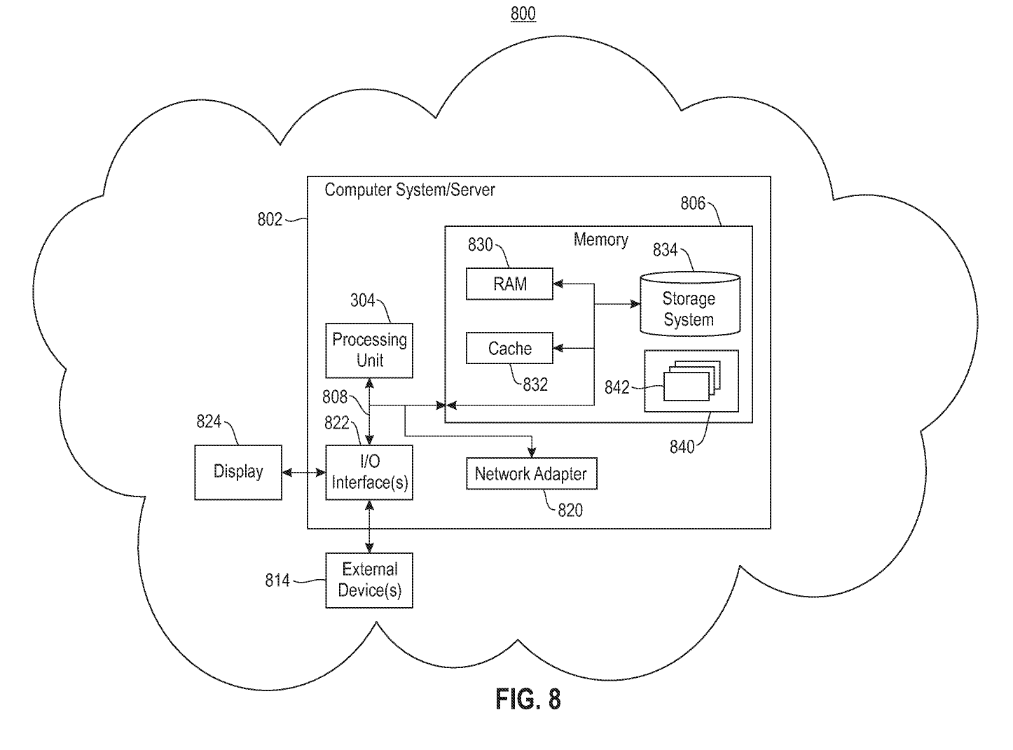

Aspects of dynamic resolution of autonomic compression shown in FIGS. 1-7, employ one or more functional tools to support balancing performance of a compression technique and storage space savings in data storage based on an access characteristic. Aspects of the functional tool, e.g. autonomic compression engine, and its associated functionality may be embodied in a computer system/server in a single location, or in one embodiment, may be configured in a cloud based system sharing computing resources. With references to FIG. 8, a block diagram (800) is provided illustrating an example of a computer system/server (802), hereinafter referred to as a host (802) in communication with a cloud based support system, to implement the processes described above with respect to FIGS. 1-7. Host (802) is operational with numerous other general purpose or special purpose computing system environments or configurations. Examples of well-known computing systems, environments, and/or configurations that may be suitable for use with host (802) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (802) may be described in the general context of computer system-executable instructions, such as program modules, being executed by a computer system. Generally, program modules may include routines, programs, objects, components, logic, data structures, and so on that perform particular tasks or implement particular abstract data types. Host (802) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, host (802) is shown in the form of a general-purpose computing device. The components of host (802) may include, but are not limited to, one or more processors or processing units (804), a system memory (806), and a bus (808) that couples various system components including system memory (806) to processor (804). Bus (808) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (802) typically includes a variety of computer system readable media. Such media may be any available media that is accessible by host (802) and it includes both volatile and non-volatile media, removable and non-removable media.

Memory (806) can include computer system readable media in the form of volatile memory, such as random access memory (RAM) (830) and/or cache memory (832). By way of example only, storage system (834) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (808) by one or more data media interfaces.

Program/utility (840), having a set (at least one) of program modules (842), may be stored in memory (806) by way of example, and not limitation, as well as an operating system, one or more application programs, other program modules, and program data. Each of the operating systems, one or more application programs, other program modules, and program data or some combination thereof, may include an implementation of a networking environment. Program modules (842) generally carry out the functions and/or methodologies of embodiments to autonomic data compression for balancing performance of a compression technique and storage space savings in data storage based on an access characteristic. For example, the set of program modules (842) may include the modules configured as an autonomic compression engine as described in FIGS. 1-7.

Host (802) may also communicate with one or more external devices (814), such as a keyboard, a pointing device, etc.; a display (824); one or more devices that enable a user to interact with host (802); and/or any devices (e.g., network card, modem, etc.) that enable host (802) to communicate with one or more other computing devices. Such communication can occur via Input/Output (I/O) interface(s) (822). Still yet, host (802) can communicate with one or more networks such as a local area network (LAN), a general wide area network (WAN), and/or a public network (e.g., the Internet) via network adapter (820). As depicted, network adapter (820) communicates with the other components of host (802) via bus (808). In one embodiment, a plurality of nodes of a distributed file system (not shown) is in communication with the host (802) via the I/O interface (822) or via the network adapter (820). It should be understood that although not shown, other hardware and/or software components could be used in conjunction with host (802). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (806), including RAM (830), cache (832), and storage system (834), such as a removable storage drive and a hard disk installed in a hard disk drive.

Computer programs (also called computer control logic) are stored in memory (806). Computer programs may also be received via a communication interface, such as network adapter (820). Such computer programs, when run, enable the computer system to perform the features of the present embodiments as discussed herein. In particular, the computer programs, when run, enable the processing unit (804) to perform the features of the computer system. Accordingly, such computer programs represent controllers of the computer system.

In one embodiment, host (802) is a node (810) of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

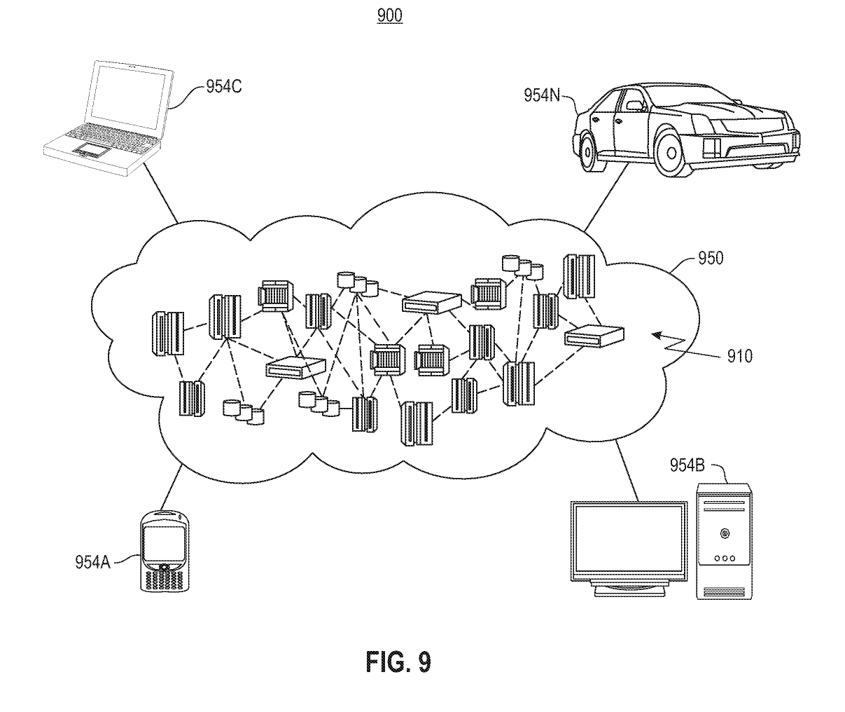

Referring now to FIG. 9, an illustrative cloud computing network (900). As shown, cloud computing network (900) includes a cloud computing environment (950) having one or more cloud computing nodes (910) with which local computing devices used by cloud consumers may communicate. Examples of these local computing devices include, but are not limited to, personal digital assistant (PDA) or cellular telephone (954A), desktop computer (954B), laptop computer (954C), and/or automobile computer system (954N). Individual nodes within nodes (910) may further communicate with one another. They may be grouped (not shown) physically or virtually, in one or more networks, such as Private, Community, Public, or Hybrid clouds as described hereinabove, or a combination thereof. This allows cloud computing environment (900) to offer infrastructure, platforms and/or software as services for which a cloud consumer does not need to maintain resources on a local computing device. It is understood that the types of computing devices (954A-N) shown in FIG. 9 are intended to be illustrative only and that the cloud computing environment (950) can communicate with any type of computerized device over any type of network and/or network addressable connection (e.g., using a web browser).

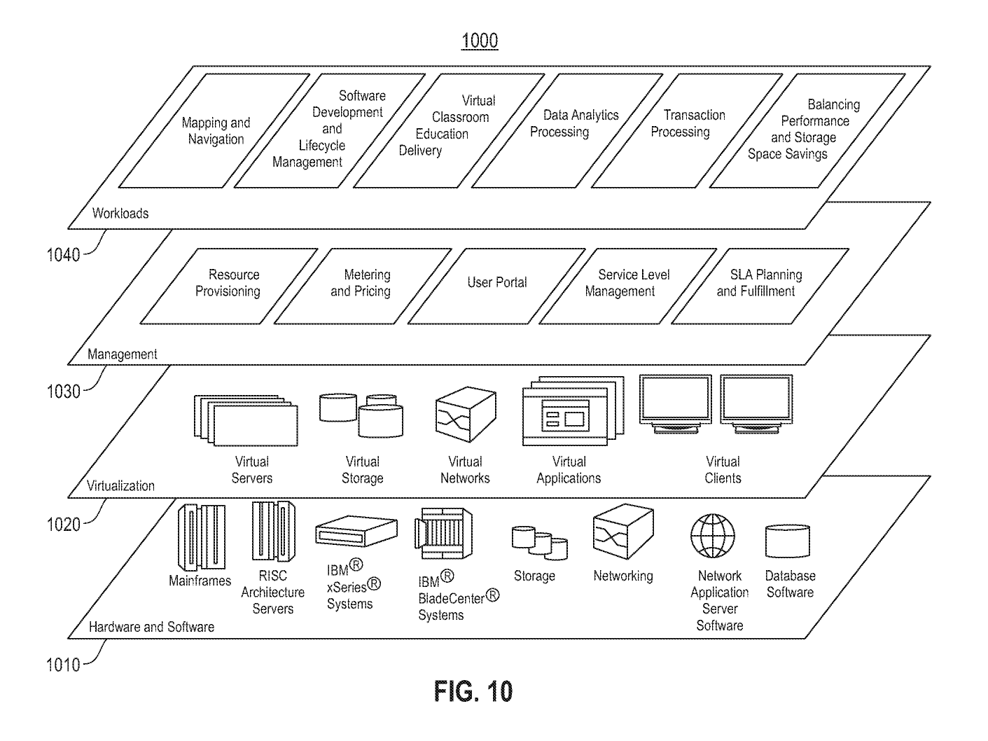

Referring now to FIG. 10, a set of functional abstraction layers (1000) provided by the cloud computing network of FIG. 9 is shown. It should be understood in advance that the components, layers, and functions shown in FIG. 10 are intended to be illustrative only, and the embodiments are not limited thereto. As depicted, the following layers and corresponding functions are provided: hardware and software layer (1010), virtualization layer (1020), management layer (1030), and workload layer (1040). The hardware and software layer (1010) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1020) provides an abstraction layer from which the following examples of virtual entities may be provided: virtual servers; virtual storage; virtual networks, including virtual private networks; virtual applications and operating systems; and virtual clients.

In one example, management layer (1030) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (1040) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and balancing performance and storage space savings.

The present embodiments may be a system, a method, and/or a computer program product. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A computer readable signal medium includes a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium is any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single dataset, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of the disclosed embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated. Autonomic compression balances performance of a compression technique and storage space savings in data storage based on an access characteristic thereby optimizing utilization of system resources.

It will be appreciated that, although specific embodiments have been described herein for purposes of illustration, various modifications may be made without departing from the spirit and scope of the embodiments. In particular, any quantity or type of compression techniques may be employed. The quantity and types of states of compression of file data should not be considered limiting. Additionally, the position of the autonomic compression engine (112) and manager (132) should not be considered limiting. Accordingly, the scope of protection of these embodiments is limited only by the following claims and their equivalents.

1. A computer system comprising:
a processing unit in communication with data storage; and
an autonomic compression engine in communication with the processing unit for file data management, the autonomic compression engine to:
determine an access characteristic of file data, wherein the access characteristic includes a timestamp of a most recent file data access;
dynamically select a space management action to be applied to the file data based on the determined access characteristic, the space management action associated with a compression ratio and a performance characteristic of the space management action, wherein the selection includes to automatically balance between a storage size and an access performance of the file data; and
apply the selected space management action on the file data, wherein the space management action includes at least one technique selected from the group consisting of: compression, de-compression, and re-compression.

2. The system of claim 1, wherein the access characteristic further includes an access pattern including randomness of access.

3. The system of claim 1, further comprising the autonomic compression engine to:
determine a time for the selected space management action to be performed based on the determined access characteristic, the time selected from the group consisting of: in-line and out-of-line, wherein performing the space management action is in accordance with the determined time.

4. The system of claim 1, wherein to determine the access characteristic includes the autonomic compression engine to examine the timestamps corresponding to the most recent read and write accesses of the file data.

5. The system of claim 4, further comprising the autonomic compression engine to:
apply an autonomic multi-tier reaction system to the file data, including:
compare the access characteristic to an access threshold; and
determine a state of compression of the file data;
wherein to dynamically select the space management action to be applied to the file data incorporates the access characteristic comparison and the determined state of compression; and
wherein the compression technique is one of a first compression technique and a second compression technique, the first compression technique has a first performance characteristic, a first compression ratio, and creates a first state of compression of the file data and the second compression technique has a second performance characteristic, a second compression ratio, and creates a second state of compression of the file data, the first and second states are different, the first and second compression ratios are different, and the first and second performance characteristics are different.

6. The system of claim 5, further comprising the autonomic compression engine to:
select the first compression technique in response to a determination that the file data is in an uncompressed state; and
perform the first compression technique on the file data in the uncompressed state.

7. The system of claim 5, further comprising the autonomic compression engine to:
select the second compression technique in response to a determination that the access characteristic is below the threshold based on the comparison and a determination that the file data is compressed to the first state;
decompress the file data from the first state to an uncompressed state in response to the selection of the second compression technique and the determination of the file data is compressed to the first state; and
perform the second compression technique on the file data in the uncompressed state.

8. The system of claim 5, further comprising the autonomic compression engine to:
select the first compression technique in response to a determination of the access characteristic meeting or exceeding the threshold;
decompress the file data from the second state to an uncompressed state in response to the selection of the first compression technique and a determination of the file data being compressed to the second state; and
perform the first compression technique on the file data in the uncompressed state.

9. A computer program product for file data management, the computer program product comprising a computer readable storage medium having program code embodied therewith, the program code executable by a processing unit to:
determine an access characteristic of file data, wherein the access characteristic includes a timestamp of a most recent file data access;
dynamically select a space management action to be applied to the file data based on the determined access characteristic, the space management action associated with a compression ratio and a performance characteristic of the space management action, wherein the selection includes to automatically balance between a storage size and an access performance of the file data; and
apply the selected space management action on the file data, wherein the space management action includes at least one technique selected from the group consisting of: compression, de-compression, and re-compression.

10. The computer program product of claim 9, wherein to determine the access characteristic includes program code to examine the timestamps corresponding to the most recent read and write accesses of the file data and further comprising program code to:
apply an autonomic multi-tier reaction system to the file data, including:
compare the access characteristic to an access threshold; and
determine a state of compression of the file data;
wherein to dynamically select the space management action to be applied to the file data incorporates the access characteristic comparison and the determined state of compression; and
wherein the compression technique is one of a first compression technique and a second compression technique, the first compression technique has a first performance characteristic, first compression ratio, and creates a first state of compression of the file data and the second compression technique has a second performance characteristic, a second compression ratio, and creates a second state of compression of the file data, the first and second states are different, the first and second compression ratios are different, and the first and second performance characteristics are different.

11. The computer program product of claim 10, further comprising program code to:
select the first compression technique in response to a determination that the file data is in an uncompressed state; and
perform the first compression technique on the file data in the uncompressed state.

12. The computer program product of claim 10, further comprising program code to:
select the second compression technique in response to a determination that the access characteristic is below the threshold based on the comparison and a determination that the file data is compressed to the first state;
decompress the file data from the first state to an uncompressed state in response to the selection of the second compression technique and the determination of the file data is compressed to the first state; and
perform the second compression technique on the file data in the uncompressed state.

13. The computer program product of claim 10, further comprising program code to:
select the first compression technique in response to a determination of the access characteristic meeting or exceeding the threshold;
decompress the file data from the second state to an uncompressed state in response to the selection of the first compression technique and a determination of the file data being compressed to the second state; and
perform the first compression technique on the file data in the uncompressed state.

14. A method for file data management comprising:
determining an access characteristic of file data, wherein the access characteristic includes a timestamp of a most recent file data access;
dynamically selecting a space management action to be applied to the file data based on the determined access characteristic, the space management action associated with a compression ratio and a performance characteristic of the space management action, wherein the selection includes automatically balancing between a storage size and an access performance of the file data; and
applying the selected space management action on the file data, wherein the space management action includes at least one technique selected from the group consisting of: compression, de-compression, and re-compression.

15. The method of claim 14, wherein the access characteristic further includes an access pattern selected from the group consisting of: frequency of access, size of file data accessed, and randomness of access and further comprising:
dynamically selecting a compression partition size for the space management action based on the access characteristic, wherein a first compression partition size is selected for file data with a sequential access pattern and a second compression partition size is selected for file data with a random access pattern wherein the first and second compression partition sizes are different.

16. The method of claim 14, further comprising:
determining a time for the selected space management action to be performed based on the determined access characteristic, the time selected from the group consisting of: in-line and out-of-line, wherein performing the space management action is in accordance with the determined time.

17. The method of claim 14, wherein determining the access characteristic includes examining the timestamps corresponding to the most recent read and write accesses of the file data and further comprising:
applying an autonomic multi-tier reaction system to the file data, including:
comparing the access characteristic to an access threshold; and
determining a state of compression of the file data;
wherein dynamically selecting the space management action to be applied to the file data incorporates the access characteristic comparison and the determined state of compression; and
wherein the compression technique is one of a first compression technique and a second compression technique, the first compression technique has a first performance characteristic, first compression ratio, and creates a first state of compression of the file data and the second compression technique has a second performance characteristic, a second compression ratio, and creates a second state of compression of the file data, the first and second states are different, the first and second compression ratios are different, and the first and second performance characteristics are different.

18. The method of claim 17, further comprising:
selecting the first compression technique in response to a determination that the file data is in an uncompressed state; and
performing the first compression technique on the file data in the uncompressed state.

19. The method of claim 17, further comprising:
selecting the second compression technique in response to a determination that the access characteristic is below the threshold based on the comparison and a determination that the file data is compressed to the first state;
decompressing the file data from the first state to an uncompressed state in response to the selection of the second compression technique and the determination of the file data is compressed to the first state; and
performing the second compression technique on the file data in the uncompressed state.

20. (canceled)

21. The system of claim 2, wherein the randomness of access includes a random access pattern and a sequential access pattern, and further comprising the autonomic compression engine to:
dynamically select a compression partition size for the space management action based on the randomness of access, wherein a first compression partition size is selected for file data with a sequential access pattern and a second compression partition size is selected for file data with a random access pattern, wherein the first and second compression partition sizes are different.
